(19) United States
(12) Patent Application Publication
(10) Pub. No.: US 2014/0287687 A1
(43) Pub. Date: Sep. 25, 2014

(54) METHOD AND SYSTEM FOR MANAGING BLUETOOTH BONDING FOR PRE-PAIRING AND IMPERSONATION

(71) Applicant: Elbrys Networks, Inc., Portsmouth, NH (US)

(72) Inventors: Denis Bakin, Portsmouth, NH (US); James E. Burns, Stratham, NH (US)

(73) Assignee: Elbrys Networks, Inc., Portsmouth, NH (US)

(21) Appl. No.: 14/220,969

(22) Filed: Mar. 20, 2014

Related U.S. Application Data
(60) Provisional application No. 61/803,574, filed on Mar. 20, 2013.

(51) Int. Cl. H04W 4/00; H04W 76/02

(52) U.S. Cl. CPC H04W 4/005; H04W 4/008; H04W 76/023
USPC 455/41.2

(57) ABSTRACT

Methods and systems are provided that allow Bluetooth bonding of machine-to-machine (M2M) devices to be remotely managed by a third party on behalf of a user.

### CROSS REFERENCE TO RELATED APPLICATION

This application claims priority from U.S. Provisional Patent Application No. 61/803,574 filed on Mar. 20, 2013 entitled Method and System for Managing Bluetooth Bonding for Pre-Pairing and Impersonation, which is hereby incorporated by reference.

### BACKGROUND

The present application relates generally to methods and systems for managing bonding of machine-to-machine (M2M) devices using a wireless technology standard such as Bluetooth for exchanging data between the devices.

Many services for consumers include an M2M device as part of the service. For example, a service for monitoring fitness may utilize a wireless pedometer worn by the user. A service for managing chronic care for a patient may use a blood pressure monitor. A home automation service may use an M2M light switch. A smart energy service may utilize a wireless thermostat. These and other such services increase the number of M2M devices for a user to manage. As this occurs, the process of preparing these devices to begin communicating with each other (pairing) will need to be done more often and by a greater percentage of the population. This trend creates a number of issues, including: issues with pairing to more than one device, pairing by individuals without technical aptitude, and potential security risks from mis-pairing.

Multiple pairings is not supported by many Bluetooth M2M devices. An individual may carry an M2M device with them and expect it to connect with more than one other device. Each pair of devices requires its own pairing. Because many Bluetooth M2M devices are limited to a single pairing, when they are paired with a new device they forget about the first device with which they were paired. This results in the individual needing to pair repeatedly.

Services are often offered to all consumers regardless of their technical skills or aptitude. If a service involves the installation of one or more Bluetooth M2M devices, those consumers who are not technically savvy may be confused by the unfamiliar Bluetooth discovery and pairing process. This will result in a significant support burden for the service provider and may result in service cancellations by frustrated customers. An example of a service that requires installation of Bluetooth M2M devices is a wellness service prescribed to a chronic healthcare patient that includes a set of wireless healthcare devices such as a blood pressure monitor, a blood oximeter, or a blood glucometer.

Pairing two Bluetooth devices creates a trusted relationship between the two devices over which they will freely share data. If a pairing is made with an incorrect device, then data may be shared with an unintended third party. This may occur due to user error because the user was offered multiple devices with which to pair and chose the wrong one. It may also occur as a result of a malicious attack where an attacker's device appears as an option for pairing, and the unsuspecting user pairs with it by accident. The end result of an incorrect pairing is the loss of data privacy, data origin integrity, and data integrity.

Bluetooth devices wirelessly communicate with each other over a short-range (typically up to 5-30 meters). Most types of Bluetooth communication requires that the two devices be ‘bonded’. Bonded devices share a secret called a link key. The link key is unique for each bonded pair. The link key is used in conjunction with a Bluetooth device's Extended Unique Identifier (EUI) to authenticate the devices and generate keys for encrypting data passed between them. Without this link key, the Bluetooth devices will not be able to carry out secure communication. The link key is created between the two devices by a process called pairing.

Bluetooth pairing is the process of two devices creating a shared link key. Before pairing can occur the two devices must discover one another.

The Bluetooth discovery process involves one device being discoverable and the other to be in discovery mode. Typical M2M devices are not constantly discoverable; rather a user action places them into discoverable mode. The M2M device will remain discoverable for a finite length of time (usually between 30 seconds and three minutes), after which a user action is required to place it in discoverable mode again. Similarly, the device that will discover the M2M device is not constantly in discovery mode, and a user action is needed to place it in discovery mode. This requires that an end-user coordinate the states of the two devices to ensure they find each other. An additional complexity is that placing an M2M device in discoverable mode is different for each type of device and may include activities as cumbersome as removing and reinstalling batteries. For an uninitiated person, this process is likely to be frustrating and increase support cost for the service provider.

Once two devices discover one another, the pairing process may occur. During the pairing process, the EUI of the devices to be paired is exchanged and then a link key is generated. The Bluetooth specification defines numerous ways to pair two devices. All of these involve user interaction to select the device with which to pair from a list of discovered devices (EUIs are exchanged at this point) and most involve a second user interaction to read a personal identification number (PIN) on one device and enter it into the other. There is one pairing mechanism, ‘Just Works’, that requires only the selection of a device from a list and no PIN interaction. However, this is known to be vulnerable to a man-in-the-middle (MITM) attack. If the individual selects the incorrect device from the list of discovered devices, then they may compromise the security of their data.

After the discovery and pairing process occurs once between two devices, they are bonded. In the future, the bonded devices may communicate to one another without user interaction utilizing the EUI to recognize a device and the link keys created during the bonding to authenticate the device and create a secure connection. If one of the bonded devices loses the link key, then the devices are no longer bonded and the discovery and pairing must occur again to create the bond. With M2M devices this typically occurs when the M2M device is bonded to a new device because many M2M devices can maintain only one bond at a time.

The discovery and pairing process is the most troublesome for end-users. For technically savvy users who are familiar with Bluetooth, the process can take approximately 30 seconds to bond two devices; while for the uninitiated, the process may take numerous attempts and require support phone calls. Even if those familiar with Bluetooth use their M2M device with their car and in their home, they may be repeatedly re-bonding their M2M device. This becomes especially time-consuming when users have more than one M2M device that needs re-bonding.

### BRIEF SUMMARY OF THE DISCLOSURE

In accordance with one or more embodiments, a method is provided for automatically bonding an M2M device and an M2M gateway device, both associated with a user for secured wireless transfer of data between the two devices. The M2M gateway device is capable of exchanging data with a remote system over a communications network. The method includes the steps of: (a) receiving an identifier for the M2M gateway device; (b) configuring a gateway emulation device with the identifier of the M2M gateway device to emulate the M2M gateway device; (c) pairing the gateway emulation device to the M2M device to generate a key for encrypting data exchanged by the gateway emulation device and the M2M device, and to store the identifier for the M2M gateway device and the key on the M2M device; (d) sending the M2M device to the user; and (e) transmitting the key and the identifier of the M2M device to the M2M gateway device over the communications network to enable the M2M gateway device to have a preconfigured wireless bond to the M2M device when the M2M device and the M2M gateway device are located within a connection range.

In accordance with one or more further embodiments, a computer system comprises at least one processor; memory associated with the at least one processor; and a program supported in the memory for causing automatic bonding of an M2M device and an M2M gateway device, both associated with a user for secured wireless transfer of data between the two devices. The M2M gateway device is capable of exchanging data with a remote system over a communications network. The program contains a plurality of instructions which, when executed by the at least one processor, cause the at least one processor to: (a) receive an identifier for the M2M gateway device; (b) configure a gateway emulation device with the identifier of the M2M gateway device to emulate the M2M gateway device; (c) pair the gateway emulation device to the M2M device to generate a key for encrypting data exchanged by the gateway emulation device and the M2M device, and to store the identifier for the M2M gateway device and the key on the M2M device; and (d) transmit the key and the identifier of the M2M device to the M2M gateway device over the communications network to enable the M2M gateway device to have a preconfigured wireless bond to the M2M device after the M2M device is sent to the user and the M2M device and the M2M gateway device are located within a connection range.

### BRIEF DESCRIPTION OF THE DRAWINGS

FIG. 1 is a schematic diagram illustrating a process for managing Bluetooth bonding of M2M devices in accordance with one or more embodiments.

### DETAILED DESCRIPTION

In accordance with one or more embodiments, methods and systems are provided that allow Bluetooth bonding credentials or pairing to be remotely managed by a third party on behalf of a user. The methods and systems feature pre-pairing to avoid support and security issues and impersonation to allow connection between an unmodified M2M Bluetooth device and one or more gateways with no user interaction, providing increased security, decreased support costs, and smoother mobility.

As discussed in greater detail below, after a user purchases a service involving one or more M2M devices, the devices are delivered pre-bonded to a set of managed gateway devices that use impersonation to appear as the same device to the M2M devices. When the M2M device arrives, the user may immediately begin using the device and it will connect with any managed gateway device for that user. This mechanism addresses the issues discussed above including high initial bonding support costs, security concerns, and multi-bonding frustrations.

In the exemplary embodiments described herein, Bluetooth is indicated as the wireless technology standard used for exchanging data between the M2M devices. It should be understood that this is by way of example only and that other wireless technology standards may also be utilized in the methods and systems described herein.

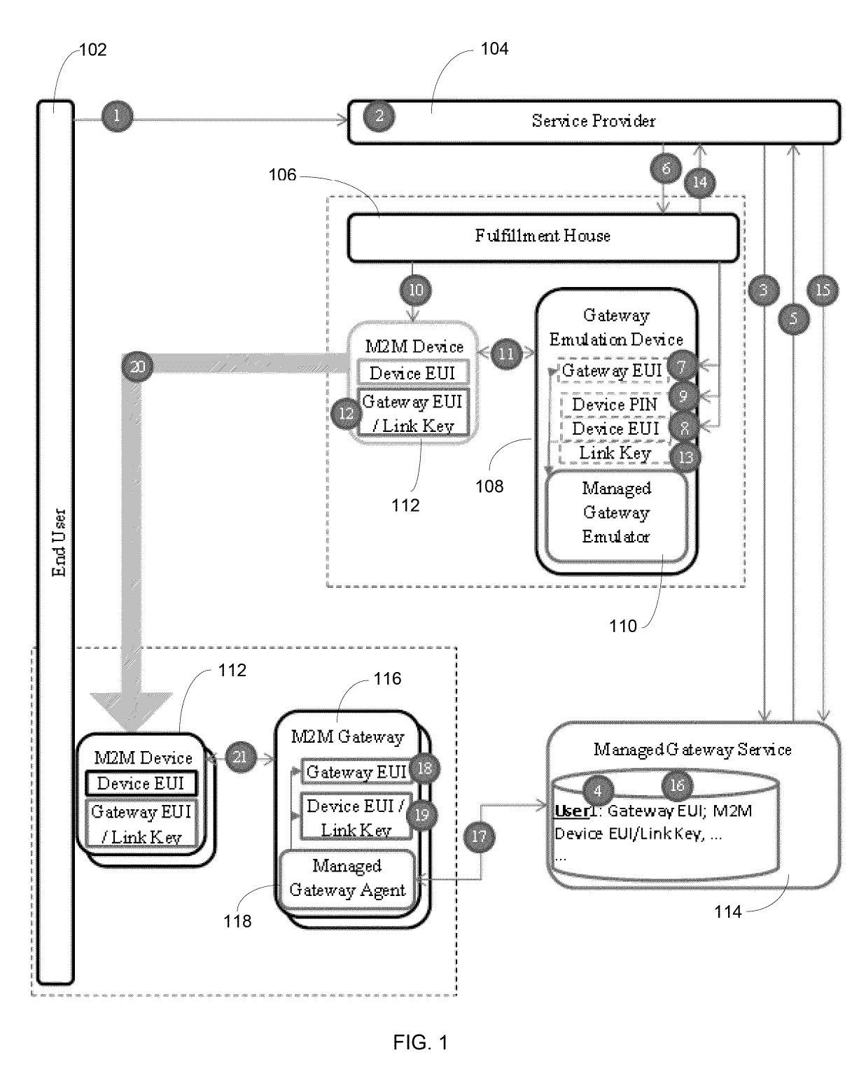

FIG. 1 illustrates a process for managing Bluetooth bonding in accordance with one or more embodiments. In the diagram, an end-user 102 is an individual who is receiving a service that requires an M2M device 112.

The Service Provider 104 and Fulfillment House 106 comprise a collection of entities that takes an order from the end-user and delivers merchandise to the end-user. These entities will typically be separate. However, they could comprise a single entity.

The Gateway Emulation Device 108 is an electronic machine that includes at least one computer processor and a storage medium readable by the processor for storing applications and data. The Gateway Emulation Device 108 includes a Bluetooth radio and executes a Managed Gateway Emulator 110. The Gateway Emulation Device 108 also functions as a fulfillment system to input an M2M device's EUI and optionally PIN.

The Managed Gateway Emulator 110 may be implemented in software residing on the gateway emulation device 108. Given an EUI, the Managed Gateway Emulator 110 can impersonate a specific managed gateway on the Bluetooth wireless network.

The M2M Device 112 is an electronic machine that the end-user needs in order to receive a service.

The Managed Gateway Service 114 may be implemented in software residing on a server computer system. The service maintains a data store of information on end-users being managed, their managed gateways, and M2M devices. The Managed Gateway Service 114 communicates with Managed Gateways 116 and the Service Provider 104/Fulfillment House 106 over a communications network. The communications network may comprise any network or combination of networks including, without limitation, the Internet, a local area network, a wide area network, a wireless network, and a cellular network.

The Managed Gateway 116 is an electronic machine that includes at least one computer processor and a storage medium readable by the processor for storing applications and data. The Managed Gateway 116 includes a Bluetooth radio and executes a Managed Gateway Application 118. The Managed Gateway 116 is physically located in locations where the end-user's M2M device(s) will enter its Bluetooth radio range.

Managed Gateway Application 118 may be implemented in software that resides on the Managed Gateway and communicates with M2M Devices over the Bluetooth radio of the Managed Gateway.

The Managed Gateway Agent 118 is able to pre-pair, configure a Link Key for a specific M2M Device. On Linux-based devices (including Android) this can be done with root access. For impersonation, the Managed Gateway Agent 118 configures the EUI used by Bluetooth radio.

The Service Provider and the Managed Gateway Service preferably have a pre-existing trust relationship that is represented cryptographically as a shared symmetric key or an asymmetric key pair that allows the Managed Gateway Service to authenticate and authorize information from the Service Provider.

There is a trusted and secure relationship between the M2M Gateway and the Managed Gateway Service that ensures that the M2M Gateway is not a rogue Gateway and it is a gateway for a particular end-user. This may be accomplished, e.g., utilizing a unique identifier per M2M Gateway and a shared secret between the M2M Gateway and Managed Gateway Service. When a new M2M Gateway is delivered to an end-user, the M2M Gateway is provisioned with the shared secret and the Gateway identifier and shared secret are stored in the end-user's account within the Managed Gateway Service.

FIG. 1 illustrates a process for managing Bluetooth bonding in accordance with one or more embodiments. The numbering used below for the process steps corresponds to the reference numbers shown in FIG. 1.

1. An end-user contacts the Service Provider and purchases or modifies a service that requires a M2M device.

2. The Service Provider allows the end-user to login to an existing service account or create a new account.

3. The service provider sends a request to the Managed Gateway Service with the unique end-user identifier and a request for that end-user's managed gateway EUI.

4. The Managed Gateway Service checks the request's authorization and, if valid, looks up the end-user's account. It searches for the Gateway EUI in the user's account. If they do not yet have an account, one is created. If they do not yet have a Gateway EUI, then one is selected from the range of EUI's the Managed Gateway Service has obtained from the IEEE. Otherwise, it retrieves the EUI that has previously been selected for this end-user.

5. The Managed Gateway Service returns the end-user's EUI to the Managed Gateway Emulator. If the end-user has no existing M2M Gateway, then it also indicates the end-user should be shipped an M2M Gateway.

6. The Service Provider requests fulfillment from the Fulfillment House delivering the M2M device SKU as well as the Gateway EUI for the end-user.

7. The Managed Gateway Emulator configures the Gateway Emulation Device's Bluetooth radio to emulate the Gateway EUI. It then indicates it is ready to emulate the end-user's gateway.

8. The Fulfillment House system provides the EUI for the M2M device's to the Managed Gateway Emulator. This may be through manual entry or using scanning technology.

9. If the M2M device requires a PIN, then the Fulfillment House system provides the PIN for the M2M device to the Managed Gateway Emulator. This may be through manual entry or using scanning technology.

10. The Fulfillment House system then causes the M2M device to enter discoverable mode.

11. The Managed Gateway Emulator, which can always be in discovery mode, discovers the M2M device by its Device EUI and pairs with it utilizing the provided PIN, if necessary. This is standard Bluetooth pairing as defined in the Bluetooth 4.0 Specification.

12. The pairing process causes the M2M device to be configured with a link key for the emulated Gateway EUI. This is standard behavior for Bluetooth enabled devices.

13. The pairing process causes the Managed Gateway Emulator to create a link key for the Device EUI. This is standard behavior for Bluetooth enabled devices.

14. The Fulfillment House returns the Device EUI and link key to the Service Provider.

15. The Service Provider sends the created link key and Device EUI to the Managed Gateway Service.

16. The Managed Gateway Service stores the Device EUI and associated Link Key in its secure data store for the end-user.

17. The Managed Gateway Service contacts all of the end-user's Managed Gateway Agents and delivers the new Device EUI and associated Link Key. This will allow them all carry out impersonation and appear as the same Bluetooth device to the M2M Device.

18. If for some reason the Gateway EUI has changed for the end-user and/or does not match the Gateway EUI in the end-user's Gateway Device, the Managed Gateway Agent will update it.

19. The Managed Gateway Agent causes the M2M Gateway to impersonate the end-user's EUI by configuring the M2M Gateways Bluetooth radio so that it has the Device EUI and associated Link Key, providing it with a Bluetooth bond to the M2M Device.

20. The Fulfillment House ships the M2M device to the end-user.

21. The end-user receives the M2M device and begins using it. Because the M2M Device and the M2M Gateway share a Link Key and know about each other's EUI, they have a pre-configured Bluetooth Bond and are able to connect and exchange data without the end-user having to put the M2M Device in discoverable mode or having to pair the devices. In addition, because all of the managed M2M Gateways are impersonating the same EUI and link-key, the end-user may move from the range of one gateway to another and the M2M Device will create a link with multiple gateway devices without requiring a re-bonding.

Various processes for managing Bluetooth bonding described above may be implemented in software, hardware, firmware, or any combination thereof. The processes are preferably implemented in one or more computer programs executing on a programmable computer device or system including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

What is claimed is:

1. A method of automatically bonding a machine-to-machine (M2M) device and an M2M gateway device, both associated with a user for secured wireless transfer of data between the two devices, said M2M gateway device being capable of exchanging data with a remote system over a communications network, the method comprising the steps of:
(a) receiving an identifier for the M2M gateway device;
(b) configuring a gateway emulation device with the identifier of the M2M gateway device to emulate the M2M gateway device;
(c) pairing the gateway emulation device to the M2M device to generate a key for encrypting data exchanged by the gateway emulation device and the M2M device, and to store the identifier for the M2M gateway device and the key on the M2M device;
(d) sending the M2M device to the user; and
(e) transmitting the key and the identifier of the M2M device to the M2M gateway device over the communications network to enable the M2M gateway device to have a preconfigured wireless bond to the M2M device when the M2M device and the M2M gateway device are located within a connection range.

2. The method of claim 1, wherein the identifiers for the M2M device and the M2M gateway device comprise extended unique identifiers (EUIs).

3. The method of claim 1, wherein the M2M device and the M2M gateway device are bonded using a Bluetooth wireless technology standard.

4. The method of claim 1, wherein the key comprises a link key.

5. The method of claim 1, further comprising providing the gateway emulation device with a personal identification number (PIN) of the M2M device for use when pairing with the M2M device.

6. The method of claim 1, wherein the M2M gateway device comprises one of a plurality of M2M gateway devices associated with the user, and wherein step (e) comprises transmitting the identifier of the M2M device and the key to each of the plurality of M2M gateway devices over the communications network to configure the plurality of M2M gateway devices to appear to the M2M device as the same device, and such that each M2M gateway device has a preconfigured wireless bond to the M2M device when the M2M device and the M2M gateway device are within a connection range.

7. The method of claim 1, wherein the remote system includes a managed gateway service, which collects and stores information on a plurality of users, including identifiers and keys for one or more M2M gateway devices and M2M devices associated with each user.

8. The method of claim 7, wherein the managed gateway service communicates with a service provider, which provides the M2M device to the user and processes data collected from the M2M device via the M2M gateway device.

9. The method of claim 8, wherein the managed gateway service maintains a trusted and secure relationship with the M2M gateway device.

10. The method of claim 1, wherein the M2M device comprises a fitness device, a healthcare device, or a home automation device.

11. A computer system, comprising:
at least one processor;
memory associated with the at least one processor; and
a program supported in the memory for causing automatic bonding of a machine-to-machine (M2M) device and an M2M gateway device, both associated with a user for secured wireless transfer of data between the two devices, said M2M gateway device being capable of exchanging data with a remote system over a communications network, the program containing a plurality of instructions which, when executed by the at least one processor, cause the at least one processor to:
(a) receive an identifier for the M2M gateway device;
(b) configure a gateway emulation device with the identifier of the M2M gateway device to emulate the M2M gateway device;
(c) pair the gateway emulation device to the M2M device to generate a key for encrypting data exchanged by the gateway emulation device and the M2M device, and to store the identifier for the M2M gateway device and the key on the M2M device; and
(d) transmit the key and the identifier of the M2M device to the M2M gateway device over the communications network to enable the M2M gateway device to have a preconfigured wireless bond to the M2M device after the M2M device is sent to the user and the M2M device and the M2M gateway device are located within a connection range.

12. The system of claim 11, wherein the identifiers for the M2M device and the M2M gateway device comprise extended unique identifiers (EUIs).

13. The system of claim 11, wherein the M2M device and the M2M gateway device are bonded using a Bluetooth wireless technology standard.

14. The system of claim 11, wherein the key comprises a link key.

15. The system of claim 11, wherein the processer is further caused to provide the gateway emulation device with a personal identification number (PIN) of the M2M device for use when pairing with the M2M device.

16. The system of claim 11, wherein the M2M gateway device comprises one of a plurality of M2M gateway devices associated with the user, and wherein (e) comprises transmitting the identifier of the M2M device and the key to each of the plurality of M2M gateway devices over the communications network to configure the plurality of M2M gateway devices to appear to the M2M device as the same device, and such that each M2M gateway device has a preconfigured wireless bond to the M2M device when the M2M device and the M2M gateway device are within a connection range.

17. The system of claim 11, wherein the remote system includes a managed gateway service, which collects and stores information on a plurality of users, including identifiers and keys for one or more M2M gateway devices and M2M devices associated with each user.

18. The system of claim 17, wherein the managed gateway service communicates with a service provider, which provides the M2M device to the user and processes data collected from the M2M device via the M2M gateway device.

19. The system of claim 18, wherein the managed gateway service maintains a trusted and secure relationship with the M2M gateway device.

20. The system of claim 11, wherein the M2M device comprises a fitness device, a healthcare device, or a home automation device.
